(19) United States
(12) Patent Application Publication
(10) Pub. No.: US 2008/0019814 A1
(43) Pub. Date: Jan. 24, 2008

(54) TRAILER FOR OFF-ROAD TOWING OF VEHICLES

(76) Inventors: PAUL ALBERT JOSEPH PLANTE, Blythewood, SC (US); GILBERT CLARENCE REED, Strong, ME (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 11/458,547

(22) Filed: Jul. 19, 2006

(51) Int. Cl. B60P 1/04

(52) U.S. Cl. 414/482

(57) ABSTRACT

A tiltable trailer for off-road carrying of off-road vehicles, comprising a rectangular frame having a triangular shaped front end, a rear end, left and right sides, and at least one cross support member; a bed supported by the frame and capable of supporting a vehicle; an elongated tongue structure extending from the frame; a tilting mechanism associated with the tongue structure to selectively retain the bed supporting frame in contact with the tongue structure or to release the frame from aid tongue structure to allow the frame to tilt; at least two axle-mounted wheels coupled by the axle to the frame; a first wheel well associated with the left side of the frame and disposed within the periphery of the frame; and, a second wheel well associated with the right side of the frame and disposed within the periphery of the frame.

### FIELD OF THE INVENTION

The present invention relates to trailers for off-road and on-road transportation of vehicles, such as all-terrain vehicles, as well as other objects.

### BACKGROUND OF THE INVENTION

Trailers are commonly used to haul vehicles, such as all-terrain vehicles (“ATVs”). These trailers are hitched to a towing vehicle when needed and unhitched for storage. These trailers are typically designed for use on smooth roads or paths only. There are no efficient and durable trailers designed for off-road use. Since the trailers are often towed in rough terrain the trailer frame frequently encounters objects, such as tree trunks, branches, rocks, dirt mounds, ditches, holes and other objects incurring significant damage. Most trailers are not designed to withstand sufficiently the variety and intensity of abuse that is commonly encountered.

It would be desirable to have a trailer designed to haul ATVs and other vehicles and objects to off-road locations and just as well as readily be towed totally off road by the ATV And have such trailer be designed to withstand the conditions for such use.

### SUMMARY OF THE INVENTION

Generally described, the present invention provides in a first exemplary embodiment a tiltable trailer for on-road and off-road carrying of off-road vehicles, comprising a rectangular frame having a triangular shaped front end, a rear end, left and right sides, and at least one cross support member; a bed supported by the frame and capable of supporting a vehicle; an elongated tongue structure extending from the frame; a tilting mechanism associated with the tongue structure to selectively retain the bed supporting frame in contact with the tongue structure or to release the frame from aid tongue structure to allow the frame to tilt; at least two axle-mounted wheels coupled by the axle to the frame; a first wheel well associated with the left side of the frame and disposed within the periphery of the frame; and, a second wheel well associated with the right side of the frame and disposed within the periphery of the frame.

The trailer bed tilts when a locking pin is removed. In the tilted position an ATV can be loaded onto the trailer via the rear portion. When the ATV is positioned on the trailer the ATV wheels are cradled between the trailer wheel wells, reducing front-to-back movement when the trailer is in motion. The wheel wells are positioned inside the frame so as to reduce the possibility of becoming damaged by hitting objects (e.g., trees, branches, brush, etc.) and becoming dented.

Other features and advantages of the present invention will become apparent upon reading the following detailed description of embodiments of the invention, when taken in conjunction with the appended claims.

### BRIEF DESCRIPTION OF THE DRAWINGS

The invention is illustrated in the drawings in which like reference characters designate the same or similar parts throughout the Figures of which:

FIG. 1 is a schematic perspective view of one exemplary embodiment of the present invention shown in the tilted position.

FIG. 2 is a top plan view.

FIG. 3 is a bottom plan view.

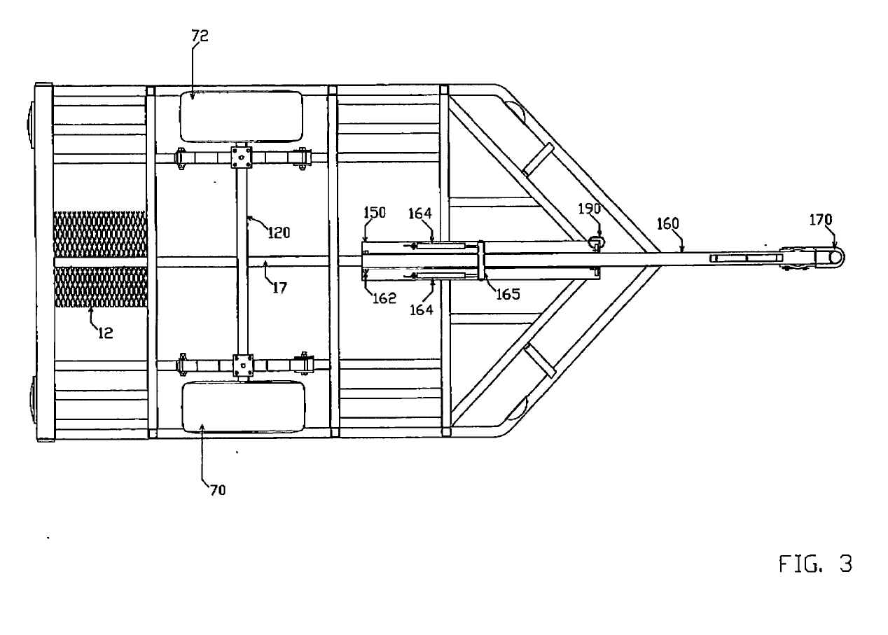

FIG. 4 is a side elevation view.

FIG. 5 is a front elevation view.

FIG. 6 is a rear elevation view.

FIG. 7 is a detail showing a portion of the axle area.

FIG. 8 is a schematic perspective and partial bottom view showing the trailer in a tilted position.

FIG. 9 is a detail showing the front portion of the tongue.

### DETAILED DESCRIPTION OF THE INVENTION

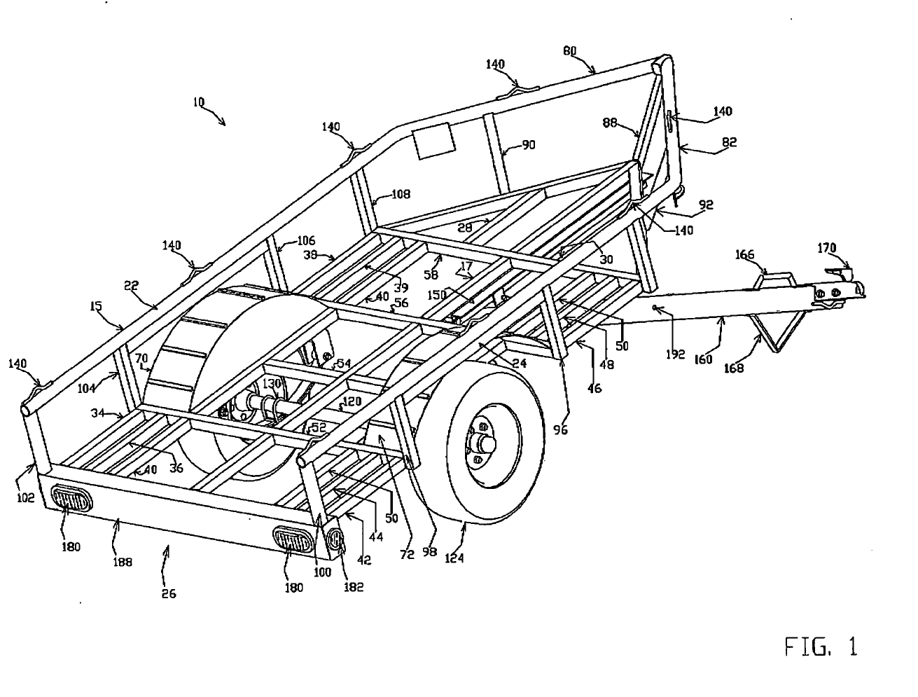

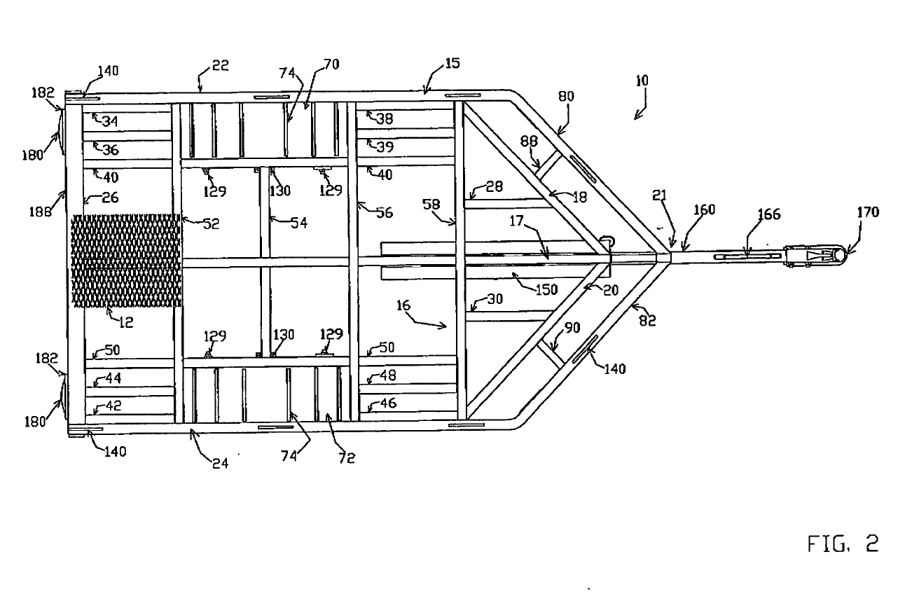

The present invention generally provides a trailer for hauling vehicles, particularly off-road vehicles, such as all-terrain vehicles (“ATVs”), and the like, behind a towing vehicle as well as being just as readily towed behind an ATV. In one exemplary embodiment, shown in FIG. 1, a trailer 10 is shown, comprising a bed 12 (a portion of which is shown in FIG. 2) attached to a frame 14. The bed is preferably a grid of “expanded” metal forming a grid or mesh, as is known to those skilled in the art and commercially available from a number of manufacturers. While a solid bed 12 can be used, a grid or mesh structure is preferable to reduce weight while maintaining strength, and, to allow dirt and water to pass therethrough, making cleaning easier and reducing standing water and dirt buildup. The bed covers at least a portion of the frame 14.

The frame 14 comprises a bed frame 16 and a rail structure 15 raised from the bed frame 16 and connected by a plurality of connecting braces. In a preferred embodiment the frame 14 components are made of a generally rigid durable material, such as, but not limited to, steel, composite, alloy, aluminum, wood, plastic, combinations thereof or other suitable material that can structurally withstand substantial stress and be able to support the weight of an ATV or other load. It is to be understood by those skilled in the art that other existing materials or materials developed hereafter can be used. The frame 14 can also be constructed of a mixture or combination of materials, depending on structural requirements and manufacturing capabilities. In more detail, the bed frame 16 includes a spine rail 17 to which is attached a pair of front rails 18, 20, the front rails 18, 20 preferably forming a wedge or triangular shaped front portion 21 of the trailer 10. The bed frame 16 also includes a first side rail 22, a second side rail 24 and a rear rail 26. The bed frame 16 also includes a plurality of support rails, which may include, depending on the particular construction, front support rails 28, 30, first side support rails 32, 34, 36, 38 and 40, second side support rails 42, 44, 46, 48 and 50, and transverse support rails 52, 54, 56, and 58. It is to be understood by those skilled in the art that fewer or additional support rails may be employed and such support rails may be longitudinal (with respect to the spine rail 17), transverse or at an angle.

A first wheel well 70 is disposed between the first side rail 22 and the support rail 40, and, in a complementary fashion, a second wheel well 72 is disposed between the second side rail 24 and the support rail 50. The wheel wells 70, 72 each comprise a curved segment of material 73 which is affixed to at least one of the rails. The wheel wells 70, 72 also preferably, though not mandatorily, have a series of spaced-apart bumps 74, which can also be treads, ribs, protrusions, nips, rounded spikes, a grate, grid or the like, to increase the traction of a tire rolling on and over the wheel well 70 or 72 to grip the wheel well surface 73. A unique feature of the present invention is the location of the wheel wells 70 and 72 within the frame 12 (i.e., between the rails 22, 24) so as to reduce the likelihood of the well being struck by an object while the trailer 10 is being towed.

The frame 14 also includes a set of raised side rails, comprising front rails 80, 82, first side rail 84, and second side rail 86. The raised side rails also include a plurality of vertical riser support rails, such as riser support rails 90, 92, 94, 96, 98, 100, 102, 104, 106 and 108 and the like. It is to be understood by those skilled in the art that fewer or more riser support rails may be used. It is also to be understood that two or more of the aforementioned riser side rails can be a single rail that is bent.

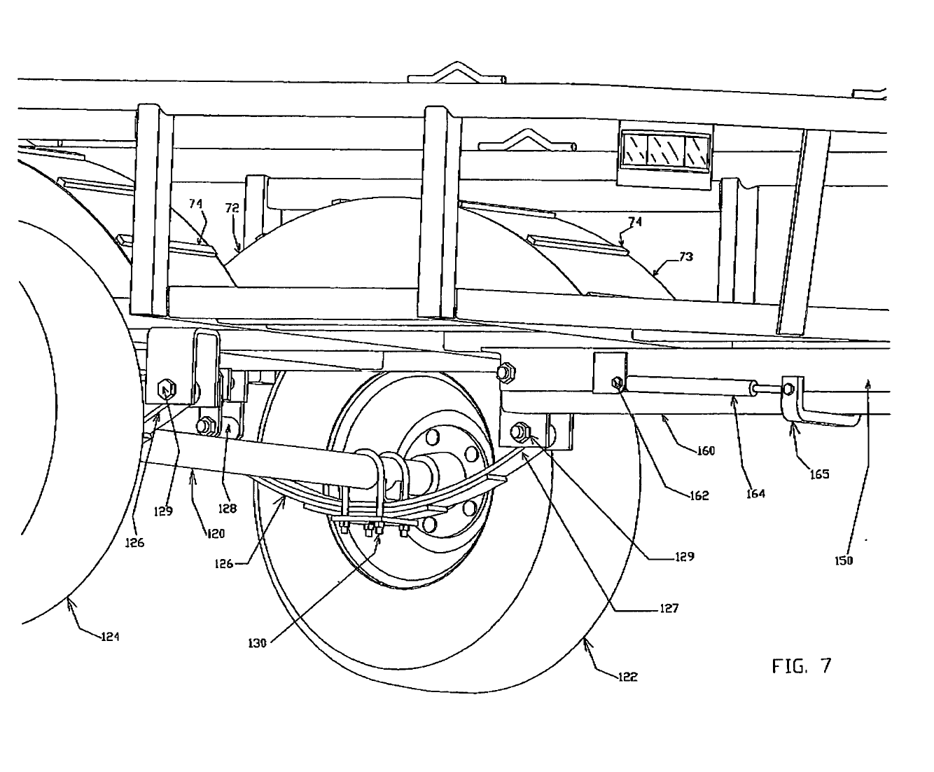

An axle 120 connects wheels 122 and 124 (see FIG. 7). The axle 120 is operatively connected to the frame 12 by a pair of springs 126, each end 127, 128 of the spring being bolted to the frame 12 using a bolt 129. The axle 120 is bolted to the springs 126 using a U-bolt 130. Optionally, a set of springs or shock absorbers (not shown) can be included, as are known to those skilled in the art. The axle 120, springs 126, and U-bolt 130 are designed to be sufficiently high from the ground to reduce the likelihood of catching objects from the ground.

The trailer 10 also preferably has at least one, and preferably a plurality of tie down loops 140 or hooks associated with the riser support rails. Is it to be understood that the loops 140 can alternatively be gaps or openings in the rail, or can be fingers, hooks, tabs, or the like, so as to enable a bungee cord, strap, rope, chain or other retention means to be strapped and attached to the frame 12. It is also contemplated that one or more loops 140 can be associated with the bed 14.

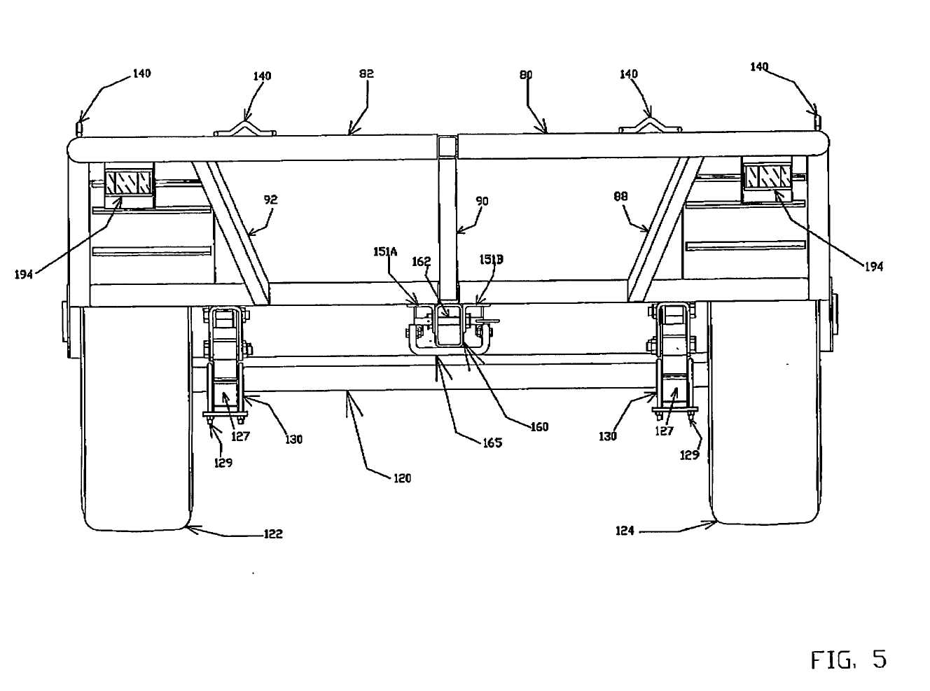

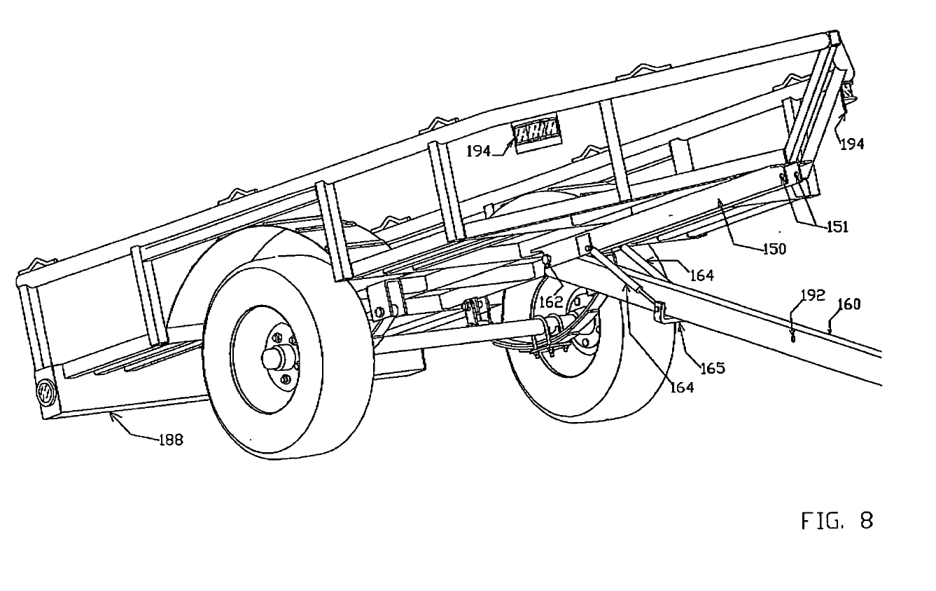

As shown in FIGS. 7-8, the frame 14 also includes a beam 150 which can be U-shaped, or composed of two L-shaped beams 151A, 151B mounted back-to-back to create a track therebetween (see FIG. 5). At least one, and preferably a pair, of holes 151 are at one end of the beam 150. A tongue 160 is pivotably mounted to the frame 14 via a pin 162 or rod and fits partially within the beam 150 while extending beyond the frame 14. At least one, and preferably a pair, of pistons 164 (such as pneumatic or hydraulic cylinders) are mounted at one end of the piston to the beam 150 and at the other end of the piston to the tongue 160. The use of the pistons 164 allows an ATV to be safely, quietly and softly loaded and unloaded onto the trailer 10 reducing any jarring or rapid motions occurring thus also securing the safety of the driver.

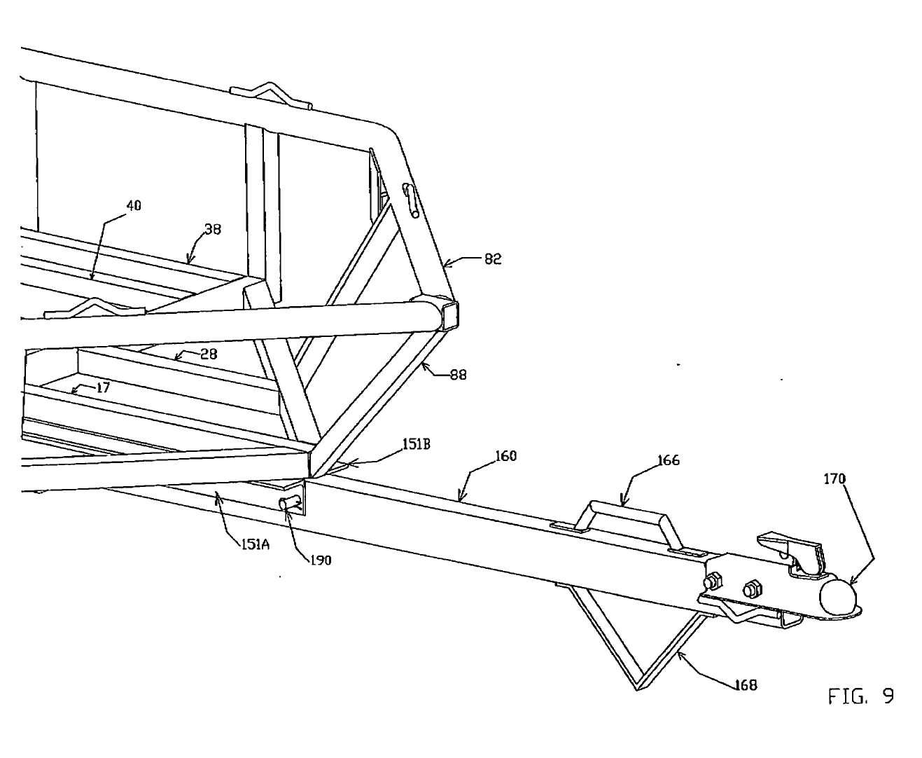

An optional handle 166 may be mounted on the top surface of the distal portion of the tongue 160 via a bracket 165 (see FIG. 9). The handle 166 allows a user to move the trailer when not attached to the towing vehicle. An optional foot 168 is mounted on the bottom surface of the distal portion of the tongue 160. The foot 168 keeps the end of the tongue 160 off the ground when not attached to a towing vehicle. A tow hitch bracket 170, known to those skilled in the art, is mounted to the end of the tongue 160 and removably connects to a mating bracket (not shown) associated with a towing vehicle.

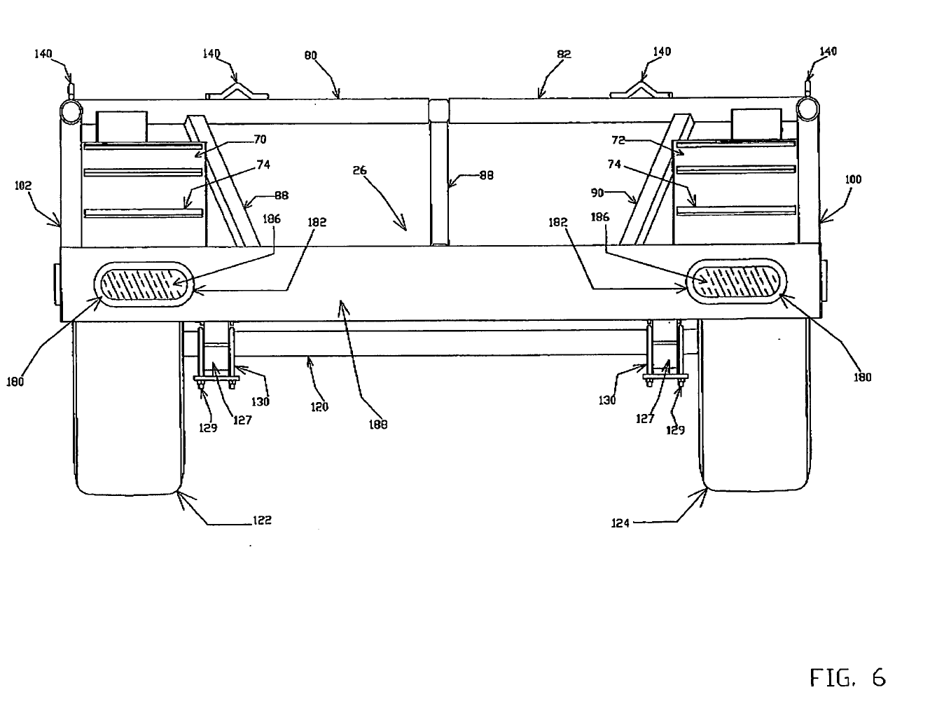

Preferably, as shown in FIG. 6, the rear portion 26 of the frame 14 has at least one, and preferably a plurality of, lights 180 comprising a fixture 182, bulb 184 and cover 186, as is conventional for trailers, but, the lights 180 are mounted in a rear rail 188 so that the cover 186 is generally flush with the rear rail 188 surface (it being understood that, depending on manufacturing design the cover 186 can be protrude from or be recessed in the surface). The flush-mount design of the lights 180 reduces the likelihood of breakage when the trailer 10 is being towed in rough areas or when the trailer is pivoted (as described in greater detail hereinbelow).

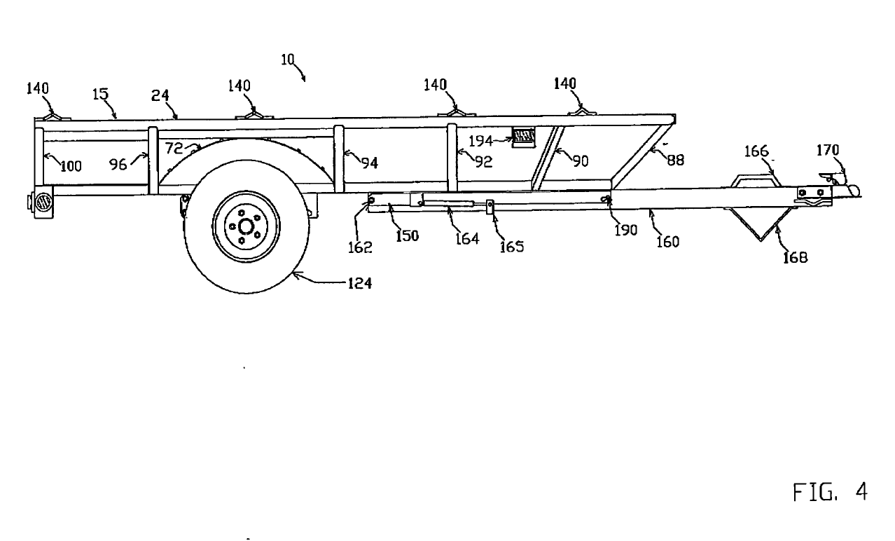

The trailer 10 can be tilted (see FIG. 4 (flat) and FIG. 8 (tilted)) to permit an ATV to be driven or otherwise positioned on the bed 12. When in the flat position (see FIGS. 4, 7) the tongue 160 fits within the track in the beam 150 and is held in place by a pin 190 which passes through a hole 192 in the tongue 150 and through the holes 151 in the beam 150. The pin 190 can be removed and the frame 14 pivots on the pin 162 so that the rear portion 26 lowers to the ground, thereby allowing an ATV to be driven over the rear rail 188 and the treaded wheel wells 70, 72 and onto the trailer 10. The pistons 164 dampen the movement of the trailer 10 with respect to the tongue 160. When the ATV is fully loaded onto the trailer 10, the wheel wells 70, 72 are disposed between the front and back ATV wheels, thereby cradling the ATV. Bungee cord or other tiedowns can be used with the loops 140 to maintain the ATV in place.

Optionally, one or more lights or reflectors 194 can be mounted on the support rails (see FIG. 6), where required by law or as desired to increase the visibility of the trailer 10.

An advantage of the present invention is the improved durability of the trailer by the incorporation of a number of novel features. One such feature is the triangular or wedge-shaped front end, which assists to deflect blows from oncoming ground objects from hitting the ATV. The front end design also allows for various gear to be placed and tied down on the trailer. Also, when the ATV is on the trailer 10, the wheel wells reduce front to back movement of the ATV wheels during hauling. Another feature is the incorporation of the wheel wells within the frame so that the wheel well is not exposed to striking object either from the front or the back or underneath to the degree that conventional trailers are exposed. The tilting design eliminates the need for separate ramps or tailgates, which reduces weight, material cost and time for loading. The bed is preferably high enough off the ground as to be able to pass over most objects and reduce the likelihood of branches or brush catching on the frame. The positioning of the U-bolts 129, 130 similarly reduces fouling.

It is to be understood that while the exemplary embodiment described above is described for use with an ATV, the trailer can be adapted and designed and use to haul motorcycles, earth digging and moving equipment, watercraft (e.g., jet skis), ski mobiles, sleds and the like, or objects other than vehicles. The trailer of the present invention can also be towed behind an ATV in off-road conditions. So, in one exemplary application, the trailer can haul an ATV from a road to an off-road site, then the trailer can be hitched to the ATV to be hauled to a remote off-road site, thereby providing a dual purpose for the trailer of the present invention.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

It should further be noted that any patents, applications and publications referred to herein are incorporated by reference in their entirety.

What is claimed is:

1. A tiltable trailer for carrying vehicles, comprising:
a) a generally rectangular frame comprising
i) a front end having a triangular shape,
ii) a rear end,
iii) left and right sides, and
iv) at least one cross support member,
b) a bed supported by said frame and capable of supporting a vehicle;
c) an elongated tongue structure extending from said frame;
d) a tilting mechanism associated with said tongue structure to selectively retain said bed supporting frame in contact with said tongue structure or to release said frame from aid tongue structure to allow said frame to tilt;
e) at least two axle mounted wheels coupled by said axle to said frame;
f) a first wheel well associated with said left side of said frame and disposed within the periphery of said frame; and,
g) a second wheel well associated with said right side of said frame and disposed within the periphery of said frame.

2. The tiltable trailer of claim 1, wherein said tilting mechanism comprises a pivot pin associated with said tongue and said frame.

3. The tilting mechanism of claim 2, further comprising a locking pin removably disposed in an aperture defined in said tongue which mates with an aperture defined in said frame.

4. The tilting mechanism of claim 2, further comprising at least one piston having one end associated with said tongue and a second end associated with said frame.

5. The tiltable trailer of claim 4, wherein said at least one piston is a pneumatic piston.

6. The tiltable trailer of claim 1, further comprising a hitch mechanism for removably coupling said tongue to a towing vehicle.

7. The tiltable trailer of claim 1, further comprising a plurality of tie down loop members associated with and spaced around selected portions of said frame.

8. The tiltable trailer of claim 1, further comprising at least one light comprising a light bulb, a protective cover and a housing, said housing being mounted at said rear end of said frame.

9. The tiltable trailer of claim 7, wherein said at least one light is mounted within said rear end of said frame such that only said protective cover is outside of said rear end of said frame.

10. The tiltable trailer of claim 1, wherein said bed comprises a generally rigid sheet of expanded metal lath which is associated with at least a portion of said frame.

11. The tiltable trailer of claim 1, wherein said wheel well has a plurality of treads formed thereon to increase traction.

12. The tiltable trailer of claim 1, wherein said wheel wells are spaced so that when an all-terrain vehicle is placed on said trailer said wheel wells cradle the front and back wheels of said all-terrain vehicle.
